(19) United States
(12) Patent Application Publication
(10) Pub. No.: US 2010/0257613 A1
(43) Pub. Date: Oct. 7, 2010

(54) DIGITAL CONTENTS PROVIDING DEVICE AND METHOD, AND USER TEMINAL FOR PROVIDING DIGITAL CONTENTS AND METHOD THEREOF

(76) Inventors: Jae-Chul Kim, Daejeon (KR); Seong Ho Lee, Daejeon (KR); Wan Sik Choi, Daejeon (KR); Jong-Hyun Park, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/746,351

(22) PCT Filed: Sep. 16, 2008
(86) PCT No.: PCT/KR08/05457

§ 371 Date: Jun. 4, 2010

(30) Foreign Application Priority Data
Dec. 7, 2007 (KR) 10-2007-0126986

(51) Int. Cl. G06F 15/16; G06F 21/00

(52) U.S. Cl. 726/28; 709/217

(57) ABSTRACT

The present invention relates to a digital contents providing device and method. The digital contents providing device authenticates a user according to a user terminal's access, receives a request message on first digital contents from the user terminal, searches the first digital contents corresponding to the request message from among a plurality of stored digital contents, checks period information and location information registered by the user so as to use digital contents, generates a contents message based on the searched period information, location information, and first digital contents, and provides the contents message to the user terminal. According to the present invention, the DRM contents having greater security than the DRM contents provided based on the conventional time information can be provided to the user terminal.

### TECHNICAL FIELD

The present invention relates to a digital contents providing device and method. Particularly, the present invention relates to a digital contents providing device and method for providing digital rights management (DRM) contents using time and space information.

This work was supported by the IT R&D program of MIC/IITA [2007-F-040-01, Development of Indoor/Outdoor Seamless Positioning Technology].

### BACKGROUND ART

The DRM is a kind of software program for guaranteeing safe distribution of paid contents and preventing illegal distribution, and it is used as an online privacy protection means for the commercial products that are being steeply increased by wide use of file exchange programs between users such as Napster.

Even though the online digital contents are protected by copyright law, it is very difficult to control illegal web usage and ferret out law violators. The DRM skill is mainly for disabling theft of web contents as a fundamental problem solving method other than arresting an online poacher after a criminal act is generated.

Most currently used DRM skills are based on user information and time information. A device for providing DRM contents by using the DRM skill provides multi media or application programs including user information and time information to the user. Therefore, when the user attempts to use the DRM contents through a user terminal, it is required to check whether the user and the time are available based on the time and user information included in the DRM contents.

The DRM skills for using the time information and the user information have been developed in various manners, but the skill for providing the DRM contents by using space information, other than the time and user information, is still in development.

Since the skill for providing DRM contents by using time and space information provides the DRM contents based on the time and space information, it can protect copyright more safely by further increasing security compared to the skill for providing the DRM contents by using time information.

Therefore, a new DRM contents providing skill is needed so as to use the DRM contents based on the time and space information.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a digital contents providing device and method for providing digital rights management (DRM) contents using time and space information.

### Technical Solution

An exemplary embodiment of the present invention provides a device for providing digital contents including: a storage unit for storing a plurality of digital contents, period information including a period established by a user so as to use the digital contents, and location information including a location predetermined by the user so as to use the digital contents; and a contents generator for receiving a digital contents request from a user terminal, searching first digital contents corresponding to the request from the storage unit, generating a contents message based on the period information, the space information, and the searched first digital contents, and transmitting the contents message to the user terminal.

The contents generator generates the contents message in the digital rights management (DRM) message format based on the searched first digital contents, the period information, and the space information, and transmits the contents message to the user terminal.

Another embodiment of the present invention provides a method for a digital contents providing device to provide digital contents to a user terminal including: authenticating the user according to the user terminal's access; receiving a request message for first digital contents from the user terminal; searching the first digital contents corresponding to the request message from among a plurality of stored digital contents; checking period information and location information registered by the user so as to use the digital contents; and generating a contents message based on the searched period information, location information, and first digital contents, and transmitting the contents message to the user terminal.

The transmitting to the user terminal includes generating the contents message in a predetermined DRM message format based on the searched period information, location information, and first digital contents.

Yet another embodiment of the present invention provides a user terminal for transmitting/receiving data to/from a device for providing digital contents in the DRM format including: a decoder for extracting the period information, the location information, and the digital contents from the DRM contents message provided by the device, the DRM contents message including period information established by the user, location information, and the digital contents; a time and space processor for acquiring a time and a location of the user terminal; and a DRM contents processor for determining whether the time and the location of the user terminal satisfy period information and location information included in the DRM contents message.

According to an embodiment of the present invention, a digital contents providing method by a user terminal for transmitting/receiving data to/from a device for providing the digital contents in the DRM format includes: receiving the DRM contents message, the DRM contents message including period information established by the user, location information, and the digital contents; checking the period information and location information included in the received DRM contents message; checking the time and the location of the user terminal; determining whether the time and the location of the user terminal satisfy period information and location information included in the received DRM contents message; and providing the digital contents to the user when the time and the location satisfy the period information and the location information according to the determination result.

The method further includes providing none of the digital contents to the user when the time and the location do not satisfy the period information and the location information according to the determination result.

### ADVANTAGEOUS EFFECTS

According to the present invention, DRM contents having greater security than the DRM contents following the existing time information can be provided to the user terminal.

Also, since space information is inserted without changing the existing standard format, the DRM contents service using time and space and having great security can be provided without greatly changing system devices.

### DESCRIPTION OF DRAWINGS

FIG. 1 shows a block diagram of a system to which a digital contents providing device according to an exemplary embodiment of the present invention is applied.

FIG. 2 shows a block diagram of a format of a DRM contents message provided to a user terminal by a digital contents providing device according to an exemplary embodiment of the present invention.

FIG. 3 shows a data flowchart for a digital contents providing device according to an exemplary embodiment of the present invention to provide digital contents to a user terminal by using time and space information.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise”, and variations such as “comprises” and “comprising”, will be understood to imply the inclusion of stated elements but not the exclusion of any other elements. In addition, the terms “-er”, “-or”, and “module” described in the specification mean units for processing at least one function and operation and can be implemented by hardware components, software components, and combinations thereof.

A digital contents providing device and method for providing digital rights management (DRM) contents using time and space information according to an exemplary embodiment of the present invention will now be described with reference to the accompanying drawings.

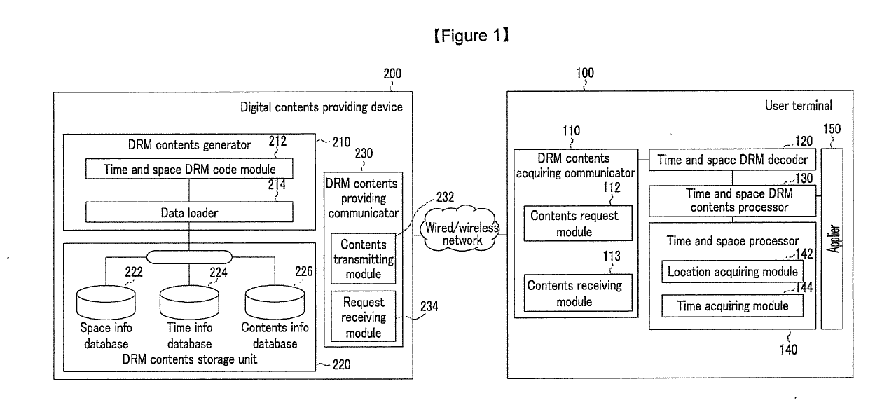

FIG. 1 shows a block diagram of a system to which a digital contents providing device according to an exemplary embodiment of the present invention is applied.

As shown in FIG. 1, the digital contents providing device 200 includes a DRM contents generator 210, a DRM contents storage unit 220, and a DRM contents providing communicator 230.

Here, the digital contents providing device 200 transmits/receives data to/from the user terminal 100 through a wired/wireless link.

The DRM contents generator 210 includes a time and space DRM code module 212 and a data loader 214, and it is connected to the DRM contents providing communicator 230 and the DRM contents storage unit 220 to transmit/receive data.

The time and space DRM code module 212 receives a DRM contents request of the user terminal 100 from the DRM contents providing communicator 230, and reads corresponding digital contents for the received DRM contents request, the accessed user's time information (period information hereinafter), and space information from the DRM contents storage unit 220. In this instance, when the user terminal 100 is connected, the time and space DRM code module 212 authenticates the user and reads time information and space information from the DRM contents storage unit 200 based on the user authentication information.

The time and space DRM code module 212 generates a DRM contents message in a predetermined format based on the read time information, space information, and digital contents. In this instance, the time and space DRM code module 212 reads time information, space information, and corresponding digital contents that are registered by the user through the data loader 214.

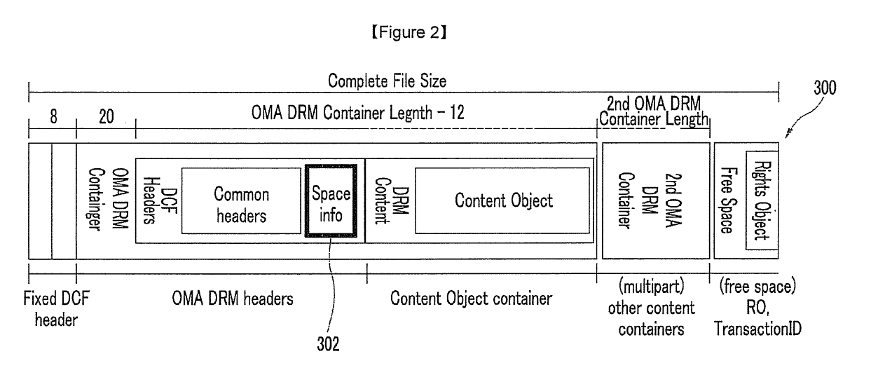

Here, the predetermined DRM contents message will be described later with reference to FIG. 2.

The data loader 214 cooperates with the time and space DRM code module 212, and provides space information, time information, and digital contents stored in the DRM contents storage unit 220 to the time and space DRM code module 212 according to a request by the time and space DRM code module 212.

The DRM contents providing communicator 230 includes a contents transmitting module 232 and a request receiving module 234.

The contents transmitting module 232 transmits the DRM contents message provided by the DRM contents generator 210 to the user terminal 100 through the wired/wireless network.

The request receiving module 234 receives a DRM contents request message from the user terminal 100 and transmits it to the DRM contents generator 210.

The DRM contents storage unit 220 includes a space information database (DB) 222, a time information database 224, and a contents information data base 226.

The space information database 222 stores space information on the users space (location) rights registered by the user. For example, space information represents the location registered by the user so as to use a DRM service, and it is randomly established such as “Samsung-dong 11111” or a specific space area (digital polygon geographical data).

The time information database 224 stores time information on the users time rights registered by the user. For example, time information represents a period registered by the user so as to use a DRM service, and it is established randomly such as “until Dec. 31, 2008” or “from Dec. 1, 2007 to Dec. 31, 2008”.

The contents information database 226 stores a plurality of digital contents. Here, the digital contents include various contents such as documents, music, images, and video.

The user terminal 100 according to the exemplary embodiment of the present invention will now be described.

The user terminal 100 includes a DRM contents acquiring communicator 110, a time and space DRM decoder 120, a time and space DRM contents processor 130, a time and space processor 140, and an applier 150.

The DRM contents acquiring communicator 110 includes a contents request module 112 and a contents receiving module 114.

The contents request module 112 receives a DRM contents request from the user, generates a DRM contents request message for requesting corresponding digital contents, and provides the DRM contents request message to the digital contents providing device 200.

The contents receiving module 114 receives a DRM contents message from the digital contents providing device 200, and provides the received DRM contents message to the time and space DRM decoder 120.

The time and space DRM decoder 120 analyzes the DRM contents message provided by the contents receiving module 114 to extract time information, space information, and digital contents, and transmits the extracted time information, space information, and digital contents to the time and space DRM contents processor 130.

The time and space DRM contents processor 130 receives the time information, space information, and digital contents from the time and space DRM decoder 120, and determines whether information on the current time acquired through the time and space processor 140 and the location of the current user terminal 100 satisfies time information and space information. The time and space DRM contents processor 130 provides digital contents to the applier 150 when information on the current time and the current location of the user terminal 100 satisfies time information and space information.

In this instance, the time and space DRM contents processor 130 requests information on the current time and the location of the user terminal 100 from the time and space processor 140, and receives a corresponding response.

The time and space processor 140 includes a location acquiring module and a time acquiring module.

The location acquiring module 142 acquires information on the location of the user terminal 100, and in detail, it acquires the location through a location acquiring system of a mobile communication service provider when it is accessible to a mobile communication network through a radio link. In this instance, when the user terminal 100 accesses a cable link, the location acquiring module 142 acquires the location by using a corresponding communication device in addition to other communication devices (a zigbee or an RF module).

Also, the location acquiring module 142 can acquire location information of the user terminal 100 from a satellite including a global positioning system (GPS) module or a global navigation satellite system (GNSS) module.

The time acquiring module 144 acquires the current time, and in more detail, it acquires the current time from a time module in the user terminal 100. In this instance, when the user terminal 100 is accessible to the mobile communication network through the radio link, it acquires time information from the mobile communication network.

Also, the time acquiring module 144 can acquire time through the time information received through the GPS module or the GNSS module.

The applier 150 provides digital contents provided by the time and space DRM contents processor 130 to the user.

FIG. 2 shows a block diagram of a format of a DRM contents message provided to a user terminal by a digital contents providing device according to an exemplary embodiment of the present invention.

As shown in FIG. 2, the digital contents device 200 uses a format of the ontology markup language (OML) DRM 2.0 REL message 300. Particularly, the time and space DRM code module 212 of the digital contents device 200 generates a DRM contents message by inserting space information 302 into a partial area of the DCF headers of the OML DRM 2.0 REL message 300.

The digital contents device according to the exemplary embodiment of the present invention generates the DRM contents message by inserting the space information without changing the existing standard format to thereby provide the DRM contents service with greater security using the time and space without substantially changing the devices of the system.

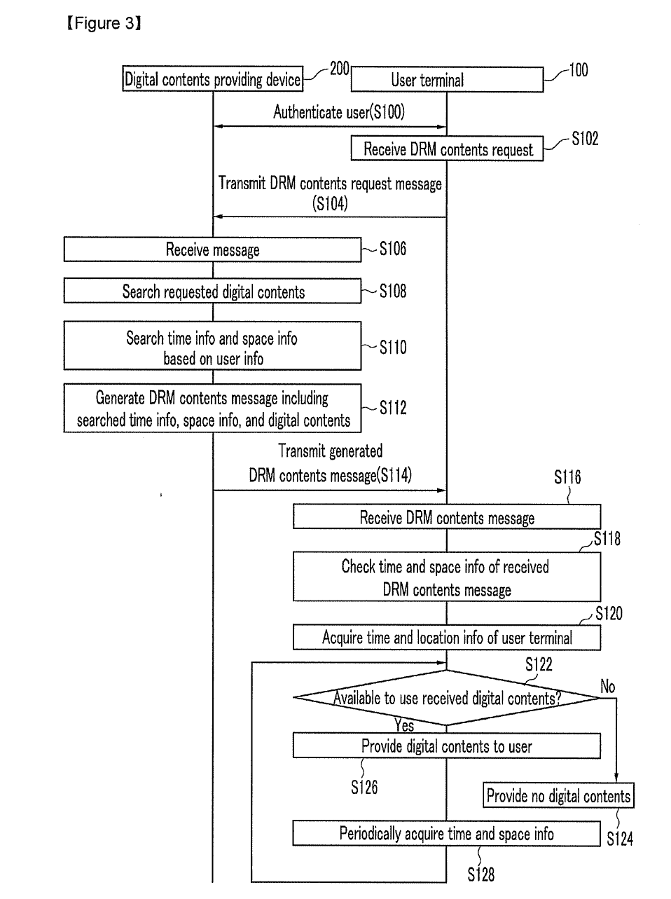

FIG. 3 shows a data flowchart for a digital contents providing device according to an exemplary embodiment of the present invention to provide digital contents to a user terminal by using time and space information.

As shown in FIG. 3, the digital contents providing method according to the exemplary embodiment of the present invention is performed when the digital contents providing device 200 authenticates the user of the user terminal 100.

The user terminal 100 accesses the digital contents providing device 200, receives user authentication information (e.g., user ID/password) from the user, transmits it to the digital contents providing device 200, and acquires user authentication (S100).

The user terminal 100 receives user authentication from the digital contents providing device 200, and when receiving a DRM contents request from the user (S102), it generates a DRM contents request message for requesting DRM contents and transmits the DRM contents request message to the digital contents providing device 200 (S104).

The digital contents providing device 200 receives the DRM contents request message from the user terminal 100 (S106), and searches the requested corresponding digital contents from the DRM contents storage unit 220 S108.

Also, the digital contents providing device 200 searches time information and space information based on the authenticated user information (S110).

The digital contents providing device 200 generates a DRM contents message in a predetermined format including searched time information, space information, and digital contents (S112), and transmits the generated DRM contents message to the user terminal 100 (S114).

The user terminal 100 receives the DRM contents message from the digital contents providing device 200 (S116), and checks time and space information of the received DRM contents message (S118).

The user terminal 100 acquires the current time and location information of the user terminal 100 (S120), and determines whether the received digital contents are available (S122). In detail, the user terminal 100 determines whether the current time and the location information of the user terminal 100 satisfy the time information and space information included in the received DRM contents message.

When the received digital contents are not available according to the determination result of S122 (when the current time and the location information of the user terminal 100 do not satisfy the time information and space information included in the received DRM contents message), the digital contents providing device 200 does not provide the corresponding digital contents to the user (S124).

When the received DRM contents are found available according to the determination result of S122 (when the current time and the location information of the user terminal 100 satisfy the time information and space information included in the received DRM contents message), the digital contents providing device 200 provides the digital contents included in the DRM contents message to the user (S126).

The digital contents providing device 200 periodically checks the time and the location information of the user terminal 100 (S128) to determine whether they satisfy the time information and space information included in the DRM contents message, and does not provide the corresponding DRM contents when they do not satisfy them.

The digital contents providing method according to the exemplary embodiment of the present invention advantageously provides DRM contents having greater security than the DRM contents that are provided based on the conventional time information.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A device for providing digital contents comprising:
a storage unit for storing a plurality of digital contents, period information including a period established by a user so as to use the digital contents, and location information including a location predetermined by the user so as to use the digital contents; and
a contents generator for receiving a digital contents request from a user terminal, searching first digital contents corresponding to the request from the storage unit, generating a contents message based on the period information, the space information, and the searched first digital contents, and transmitting the contents message to the user terminal.

2. The device of claim 1, wherein
the contents generator generates the contents message in the digital rights management (DRM) message format based on the searched first digital contents, the period information, and the space information, and transmits the contents message to the user terminal.

3. The device of claim 2, wherein
the contents generator includes:
a time and space DRM encoding module for receiving a digital contents request from the user terminal, generating the contents message based on the period information, the space information, and the searched first digital contents, and providing the contents message to the user terminal; and
a data loader for searching first digital contents corresponding to the digital contents request based on a request by the time and space DRM encoding module, the period information established by the user, and the space information from the storage unit, and providing them to the time and space DRM encoding module.

4. The device of claim 1, further comprising:
a communication device, connected to the user terminal through a cable link or a radio link, for receiving the contents request message from the user terminal to provide it to the contents generator, and receiving the contents message from the contents generator to provide it to the user terminal.

5. A method for a digital contents providing device to provide digital contents to a user terminal comprising:
authenticating the user according to the user terminal's access;
receiving a request message for first digital contents from the user terminal;
searching the first digital contents corresponding to the request message from among a plurality of stored digital contents;
checking period information and location information registered by the user so as to use the digital contents; and
generating a contents message based on the searched period information, location information, and first digital contents, and transmitting the contents message to the user terminal.

6. The method of claim 5, wherein
the transmitting to the user terminal includes
generating the contents message in a predetermined DRM message format based on the searched period information, location information, and first digital contents.

7. A user terminal for transmitting/receiving data to/from a device for providing digital contents in the digital rights management (DRM) format, the user terminal comprising:
a decoder for extracting the period information, the location information, and the digital contents from the DRM contents message provided by the device, the DRM contents message including period information established by the user, location information, and the digital contents;
a time and space processor for acquiring a time and a location of the user terminal; and
a DRM contents processor for determining whether the time and the location of the user terminal satisfy period information and location information included in the DRM contents message.

8. The user terminal of claim 7, wherein the user terminal further comprises:
an applier for receiving the digital contents from the DRM contents processor and providing them to the user, wherein
the DRM contents processor provides the digital contents to the applier when the time and the location of the user terminal satisfy the period information and the location information.

9. The user terminal of claim 7, further comprising:
a communicator for transmitting a request message for the users digital contents request to the device, receiving the DRM contents corresponding to the request message, and providing the DRM contents to the decoder.

10. A digital contents providing method by a user terminal for transmitting/receiving data to/from a device for providing the digital contents in the digital rights management (DRM) format, the method comprising:
receiving the DRM contents message, the DRM contents message including period information established by the user, location information, and the digital contents;
checking the period information and location information included in the received DRM contents message;
checking the time and the location of the user terminal;
determining whether the time and the location of the user terminal satisfy period information and location information included in the received DRM contents message; and
providing the digital contents to the user when the time and the location satisfy the period information and the location information according to the determination result.

11. The method of claim 10, further comprising:
providing none of the digital contents to the user when the time and the location do not satisfy the period information and the location information according to the determination result.

12. The method of claim 10, wherein
the checking of the time and the location of the user terminal includes
the user terminal periodically checking the time and the location.
